(19) United States
(12) Patent Application Publication
(10) Pub. No.: US 2016/0196562 A1
(43) Pub. Date: Jul. 7, 2016

(54) CUSTOMER AND BUSINESS INTERACTION SYSTEMS AND METHODS

(71) Applicant: Kipsu, Minneapolis, MN (US)

(72) Inventors: Christopher Smith, Minneapolis, MN (US); Geoffrey Dutton, Minneapolis, MN (US); Joseph Rueter, Minneapolis, MN (US)

(21) Appl. No.: 14/935,035

(22) Filed: Nov. 6, 2015

Related U.S. Application Data
(60) Provisional application No. 62/077,032, filed on Nov. 7, 2014.

(51) Int. Cl. G06Q 30/00; G06Q 50/12; G06Q 30/02; H04W 4/14; G06Q 10/06

(52) U.S. Cl. CPC G06Q 30/016; H04W 4/14; G06Q 10/06398; G06Q 30/0282; G06Q 30/0203; G06Q 50/12

(57) ABSTRACT

Embodiments of the technology include a communication process between a business and customers. In an embodiment, the technology includes contacting customers via text messaging. Other embodiments are also included herein.

This application claims the benefit of U.S. Provisional Application No. 62/077,032, filed Nov. 7, 2014, the content of which is herein incorporated by reference in its entirety.

### FIELD OF THE TECHNOLOGY

The present application relates to a process for sending messages. More specifically, the present application relates to a process for a business to communicate with a customer.

### BACKGROUND

Businesses often strive to separate themselves from their competitors by providing a higher level of service. However, a business can only solve problems that the business is aware of. Often customers will not inform a business of minor issues or problems that arise.

Accordingly, there is a need for an improved communication process between a business and its customers.

### SUMMARY

Embodiments of the invention include a process for a business to communicate with its customers, such as with text messages originated from mobile devices or other internet connected computers, including those through internet chat capabilities, mobile applications on smartphones allowing messaging over Internet Protocol, short message service through mobile telecommunications networks and the like.

In an embodiment, the invention includes establishing a conversation between a business and a customer. The process can include ranking businesses with each other by their adherence to the communication processes. The process can include ranking employees with each other by their adherence to the communication processes. The process can include a non-confrontational method of resolving a customer's problems before the customer leaves the business.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic of a process, according to an embodiment.

FIG. 2 is a schematic of a welcome message process, according to an embodiment.

FIG. 3 is a schematic of an evaluation process, according to an embodiment.

FIG. 4 is a schematic of an evaluation process, according to an embodiment.

FIG. 5 is a schematic of a status check process, according to an embodiment.

FIG. 6 is a schematic of a communication process, according to an embodiment.

FIG. 7 is a schematic of a communication routing process, according to an embodiment.

FIG. 8 is a schematic of a communication routing process, according to an embodiment.

FIG. 9 is a schematic of a communication routing process, according to an embodiment.

FIG. 10 is a schematic of a communication routing process, according to an embodiment.

FIG. 11 is a schematic of a customer mood evaluation process, according to an embodiment.

FIG. 12 is a schematic of a welcome message process, according to an embodiment.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

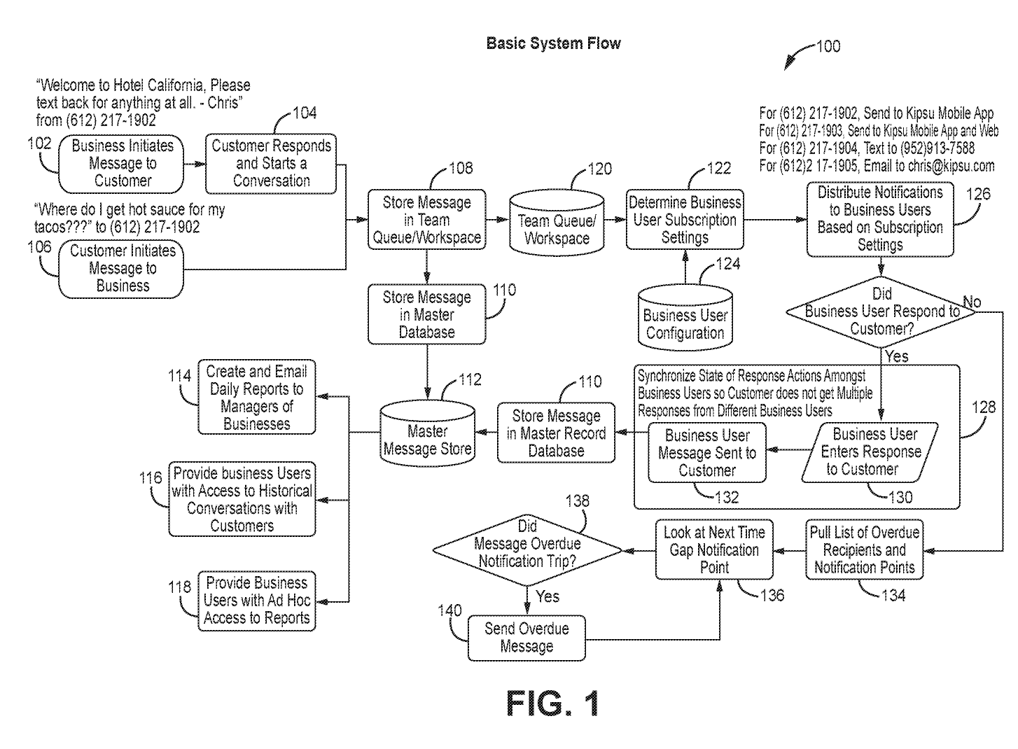

FIG. 1 is a schematic of a process 100, according to an embodiment. The process 100 can allow a business to more effectively communicate with their customers. In an embodiment, the business can be a hotel and the customers can be the guests that will stay at the hotel, are staying at the hotel, or have stayed at the hotel. The process 100 can allow for better communication between the business and the customer, such as to accommodate the needs of a guest and thereby provide the guest with a more enjoyable experience.

The business can have the systems in place to incorporate the process 100, such as a network of computers and phones. The business can initiate a message or communication with a customer 102. The message can be sent via text message to the customer. The business can receive the customer's phone number at a prior time, such as when the customer hires the business. For example, if the business is a hotel, the hotel can receive the customer's phone number when the customer books his/her room or when the customer checks into the hotel. In some embodiments, the first message between the customer and the business can take place prior to the customer's arrival at the business. The customer can respond to the message sent by the business 104, such as to start a conversation between the two parties.

In an alternative embodiment, the customer can initiate a message or communication with the business 106. The business can receive the message. In an embodiment, it is assumed that the business is willing to have a conversation with the customer and therefore a conversation can be started once the customer sends a message to the business.

The business can have an employee or group of employees designated as a team to respond to the communications from the customer(s). Messages or communications from the customer to the business can be routed or stored in a team queue or a workspace 108, such as a place where the team can see what messages have been received and need a response.

In an embodiment, the process 100 can include storing the message received in a database 110. The database can include a master message storage 112 location, such as where substantially all of the messages received by the business are saved or stored. The master message storage 112 can store received messages and messages sent by the business.

The master message storage 112 can be configured to create and email daily reports to managers or other employees of the business 114. The reports can include information such as the amount of messages received, amount of messages sent, or types of messages received.

The master message storage 112 can be configured to provide business users with access to historical conversations with the customers 116. The master message storage 112 can store substantially all messages sent and received, therefore a user can review previous messages sent to or received from a specific customer. In an embodiment, a user can prepare for a return customer's arrival by reviewing previous requests by the customer. For example, if a customer has repeatedly requested additional towels, the business can review the customer's previous requests and provide additional towels in his/her room prior to him/her requesting them.

The master message storage 112 can be configured to provide business users with ad hoc access to reports 118. For example, a user can have access to reports to review employees' performance or responsiveness to messages. A user could also have access to a report regarding the number of messages sent to different business units making up the business.

The team queue/workspace 120 can store the incoming messages until a team member can appropriately address them or until the messages can be routed to the appropriate team member. For example, if the customer has a request for additional towel, the message can be routed to a housekeeping team member.

The process 100 can include determining how the settings are configured for each business user or team member 122. Each user can have a specific configuration 124. Each team member can have his/her settings configured for his/her role on the team. For example, the housekeeping team member could have his/her settings configured to receive housekeeping related messages and not restaurant or spa related messages.

The process 100 can include distributing notifications to team members based on subscription settings 126. After the process 100 has determined the user configurations, the process 100 can distribute a notification or the message to the most appropriate team member(s).

The process 100 can determine whether or not a team member has replied to a message. If a team member has replied to a message, the process can synchronize the state of the response among the team members so the customer does not receive multiple responses from different team members 128. Multiple team members can have similarly configured settings or a message might be appropriate for team members from different business units, therefore more than one team member can receive a message. The team member can enter a response to the customer 130, such as be sending a text message as a reply to the customer. The message can be sent to the customer 132. The sent message can be stored in the master message storage 112.

The process 100 can produce a list of overdue recipients and notifications points 134. The list of overdue recipients can include customers the business has received messages from, but have yet to respond to. In an embodiment, a customer can be added to the list of overdue recipients if the message he/she sent has not been responded to within a timeframe, such as 30 minutes, 1 hour, 2 hours, 6 hours, 12 hours, or 1 day.

The process 100 can determine if an overdue message has been sent within a second timeframe 136. The second frame can be 30 minutes, 1 hour, 2 hours, 6 hours, 12 hours, or 1 day. An overdue message can be sent to a team member to remind or notify the team member that a response needs to be sent to the customer. The second timeframe can be the time between two overdue messages sent to a team member. In an embodiment, if a second overdue message is need, the process 100 can send the second overdue message to a different team member than the previous overdue message.

The process 100 can determine if a message overdue notification is triggered 138. If a message overdue notification is need, the process can send a message 140 to a team member notifying them of the customer in need of a response.

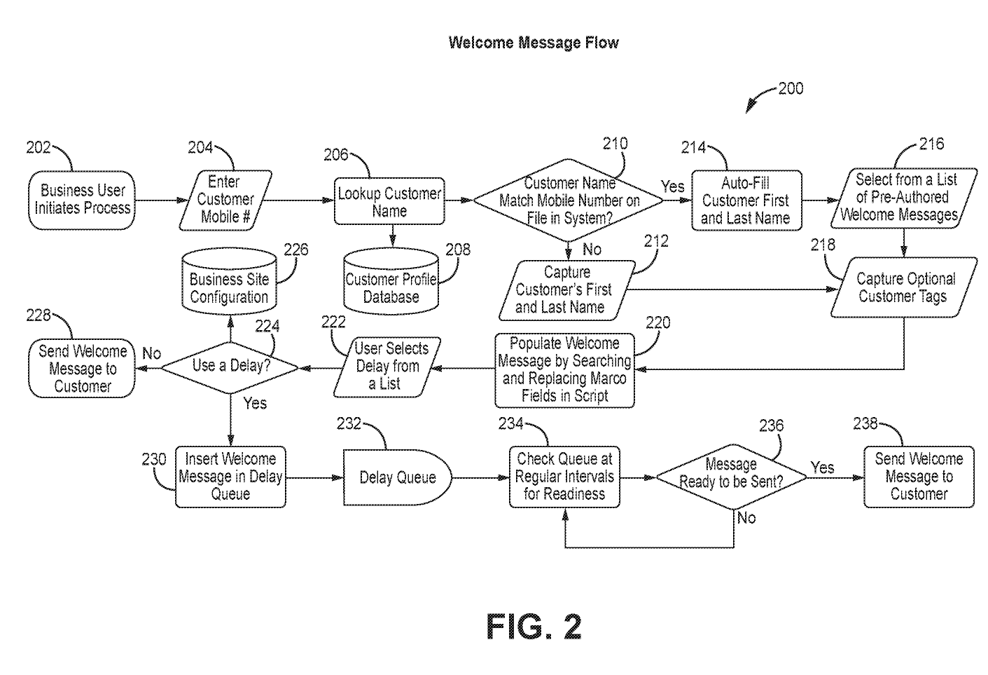

FIG. 2 shows a schematic of a welcome message process 200, according to an embodiment. A welcome message can be sent to a customer, such as when the customer checks into the business. The welcome message can initiate the conversation between the business and the customer. The welcome message can introduce the customer to the business, such as by providing a number the customer can send a text message to. In an embodiment, the welcome message can be personalized message sent by the business to greet the customer when they arrive at the business. In an embodiment, the person that the customer met at arrival sends the message and addresses the customer personally.

The process 200 can include a business user or team member initiating the process 202, such as by opening software associated with the process. The team member can enter the customer's mobile phone number 204 or in an alternative embodiment, the customer's email address. The process 200 can lookup or search the customer's name 206, such as in a customer profile database 208. The customer profile database 208 can include customers that have been previously entered in the process. In an embodiment, the customer profile database 208 can include previous messages sent and received by the customer.

The process 200 can determine if the customer's name matched a mobile number in the database 210. If the customer's name did not match, the business user can enter the customer's first and last name into the system 212. If the customer's name did match, the process 200 can auto-fill the customer's first and last names 214. The process 200 can select from a list of pre-authored welcome messages 216. The pre-authored welcome message that is selected can be sent to the customer. The process can capture optional customer tags 218 and include the optional customer tag in the welcome message to the customer.

The process 200 can populate a welcome message such as by searching and replacing macro fields in a script 220. The script can be pre-authored, such that a single team member could send multiple welcome messages to numerous customers in a relatively short amount of time.

The process 200 can include a delay, such as a delay from the time the welcome message is ready to be sent to the time the message is sent. The team member can select a delay from a list 222. The delay can be at least 30 seconds and as long as 3 hours.

The process 200 can determine if the team member has selected a delay or not 224. The delay can also be related to certain configurations for the business site 226. If a delay is not being used, the welcome message can be sent to the customer 228. If a delay is being used, the welcome message can be inserted into a delay queue 230. The delay queue 232 can include welcome messages that are delayed from being sent.

The delay queue 232 can be checked at a regular interval for readiness 234. In an embodiment, the regular interval is no longer than the shortest possible delay. If the message is ready to be sent 236 the message is sent to the customer 238. If the message is not ready to be sent 236, the message remains in the delay queue.

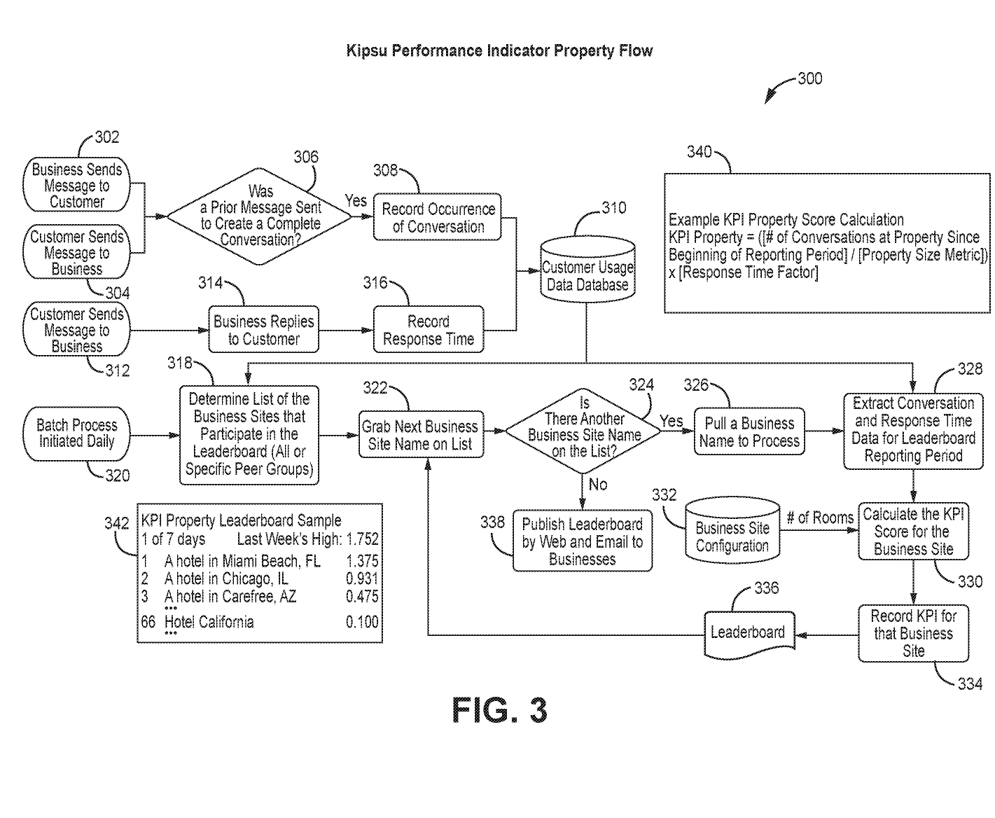

FIG. 3 shows a schematic of an evaluation process 300, according to an embodiment. The process 300 can show businesses using processes described herein, such as process 100 or process 200, are preforming in accordance with the processes and compare the businesses to each other.

The business can send a message to a customer 302 or the customer can send a message to the business 304. The process can determine if a prior message was sent to create a complete conversation 306. If a prior message was sent the process 300 can record the occurrence of the conversation 308. The record can be entered into a customer usage data database 310.

Alternatively, a customer can send a message to a business 312. The business can reply to the customer 314. The process can record the response time 316, such as the time between when the business received the customer's message and when the business sent a reply message to the customer. The information can also be stored in the customer usage data database 310.

Businesses that use the process described herein can be rated, such as by the score calculation 340. The businesses can be listed on a leaderboard 342. The businesses can be listed anonymously on the leaderboard, such that the businesses will know where they stand on the leaderboard, but do not know the identities of the other businesses.

The process 300 can include determining a list of businesses that participate in the leaderboard (all business or specific peer groups, such as commonly owned businesses) 318. The determination 318 can include a batch process 320 initiated daily of uploading or calculating the previous days results.

The process 300 can grab the next business site name on the list 322. The process can determine if another business site name is on the list 324. If there is another business site on the list the process 300 can pull a business name to calculate its performance score 326. The process 300 can include extracting conversations and response time data for leaderboard reporting period 328. The leaderboard reporting period is the time period which the leaderboard is showing data from. The process 300 can calculate the score 330. In an embodiment, the process 300 can include information specific to the business site 332, such as the number of rooms in the hotel. The calculated score can be recorded 334 and added to the leaderboard 336. If there are not any additional business site names on the list 324, the process 300 can published the leaderboards, such as by email or posting it on the Internet 338.

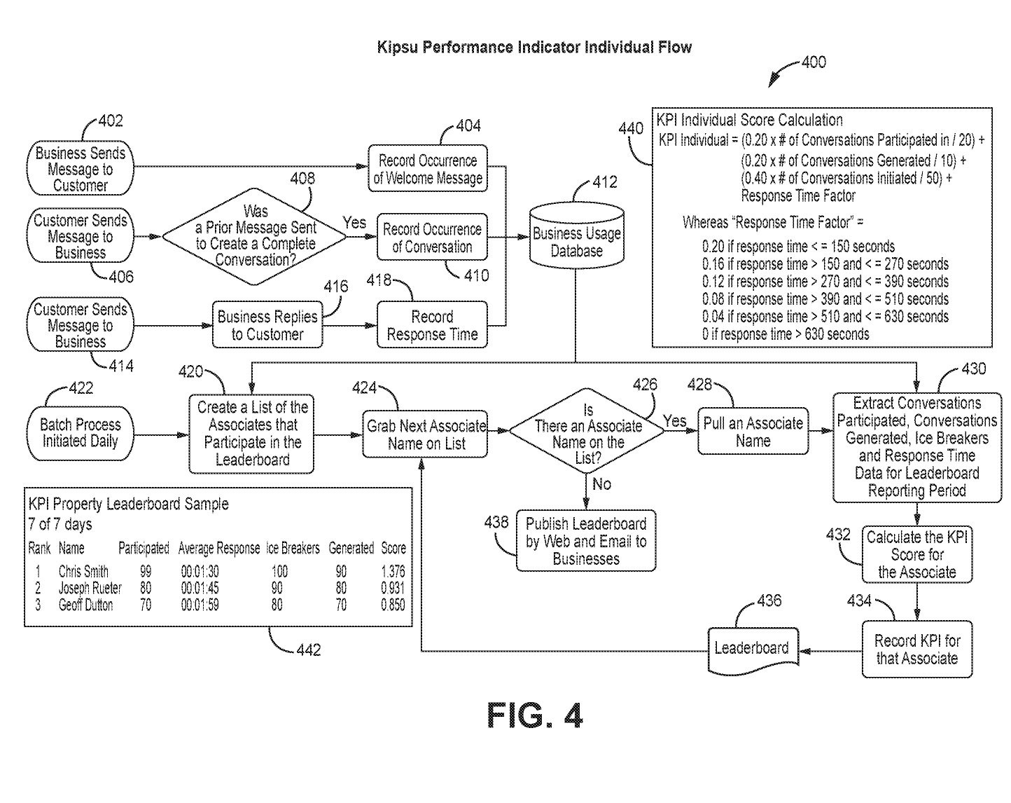

FIG. 4 shows a schematic of an evaluation process 400, according to an embodiment. The process 400 can show a business how its team members or employees are preforming with regard to the processes disclosed herein, such as process 100 or process 200. The process 400 can score and order employees based on their responses to messages received from the customers. The process 400 can show a leaderboard, such as to show how individual team members compare to each other.

The business can send a message to a customer 402. The message sent to the customer can be recorded 404. In an embodiment, the customer sends the message to the business 406. The process 400 can determine is a prior message was sent to create a complete conversation 408. The process 400 can include recording the occurrence of the conversation 410. The messages can be save, such as in a business usage database 412. In an embodiment, the customer sends a message to the business 414, the business replies to the customer 416, and the process records the response time 418.

The team members or employees of the business can be rated, such as by the score calculation 440. The employees can be listed on a leaderboard 442. The employees can be listed anonymously on the leaderboard, such that employees will know where they stand on the leaderboard, but will not know the where other employees are on the leaderboard.

The process 400 can include determining a list of employees that participate in the leaderboard (all employees or employees of a specific unit of the business) 420. The process 400 can grab the next employee on the list 424 and calculate the score for that employee. The process can determine if there is another employee on the list 426 that needs his/her score calculated. The process 400 can include pulling the employee's name 428. The process can obtain necessary information for the score calculation from the business usage database 412, such as conservations participated, conversations generated, ice breakers, and response time data 430. The process can calculate a score for the employee 432. The score can be recorded 434. The employee and score can be added to the leaderboard 436. The next employee can be grabbed of the list 424. If there are not any additional employees on the list, the leaderboard can be published 438, such as on the Internet or in an email.

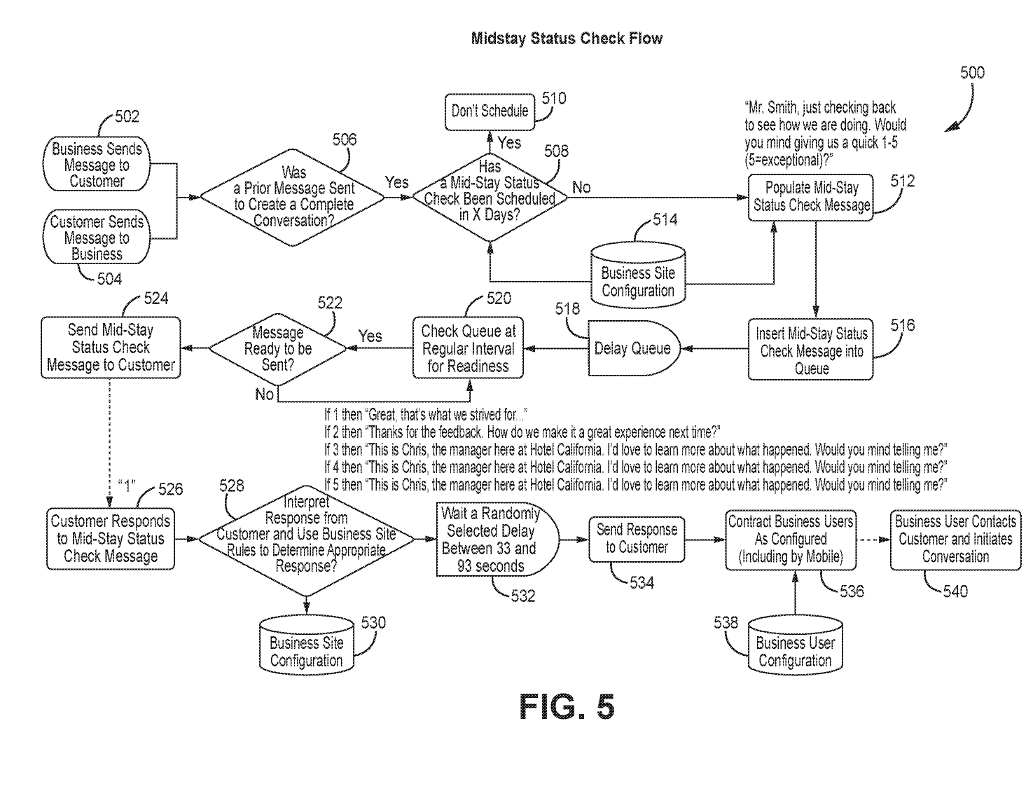

FIG. 5 shows a schematic of a mid-stay status check process 500, according to an embodiment. The mid-stay status check is a message that can be sent to a customer of the business to check in with the customer. The messages can be worded as, “Hi (customer), just checking in after our conversation yesterday. Wanted to see how we are doing. Would you mind giving us a quick 1-5 (1=excellent)?—(employee).” The status checks can allow the business to effectively detect unhappy customers that do not otherwise self-identify. The messages can be used to alert the appropriate manager or employee to perform service recovery in a socially confrontation free manner with the guess (using mobile application or text messages).

The business can send a message to the customer 502 or the customer can send a message to the business 504. The process can determine if a prior message was sent to create a complete conversation 506. The process 500 can determine if a mid-stay status check has been scheduled 508, such as in a specific number of days. If one has been scheduled, another one is not scheduled 510. If one has not been scheduled, the process 500 can populate a mid-stay status check message 512. The mid-stay status check can be dependent on the configurations of the business 514.

The process can insert the mid-stay status check message into a queue 516. The queue can wait for a given delay 518. The queue can be check at regular intervals for readiness 520, such as described above. The process 500 can determine if a message is ready to be sent 522. If the message is ready to be sent, it can be sent to the customer 524.

The customer can respond to the mid-stay status check 526. The process 500 can interpret the response from the customer and use the business site rules to determine the appropriate response 528. The response can be dependent on the business site configuration 530. The process can wait a randomly selected delay 532. The delay can be between 33 and 93 seconds. The response can be sent to the customer 534. The necessary employees can be contacted 536, such as based on the business's configuration 538. The employee can initiate a conversation 540 with the customer, such as to resolve any problems the customer has.

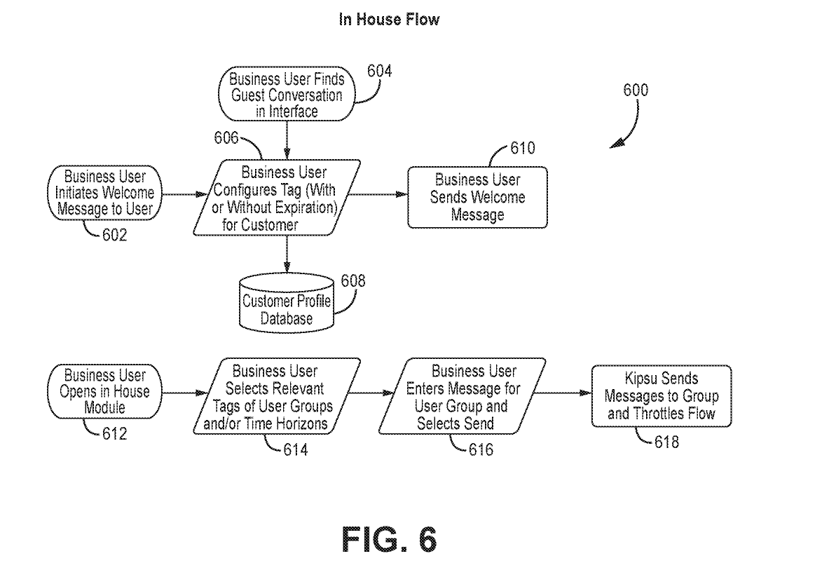

FIG. 6 is a schematic of a communication process 600, according to an embodiment. Process 600 can allow a business to broadcast a message or alert to its customers, such as to efficiently alert ambulatory customers of updates.

The process 600 can include an employee of the business initiating a welcome message to a customer 602. Alternatively, the employee can find a conversation with the guest 604. The employee can configure a tag (with or without an expiration) for the customer 606. The tag can be entered into the customer profile database 608. The employee can send a welcome message.

The employee can open an in-house module or application 612, such as software to implement the processes described herein. The employee can select relevant tags of customer groups and/or time horizons 614. The employee can enter a message for the customer group and select to send the message 616. The process 600 can send the message to the group and throttle the flow 618.

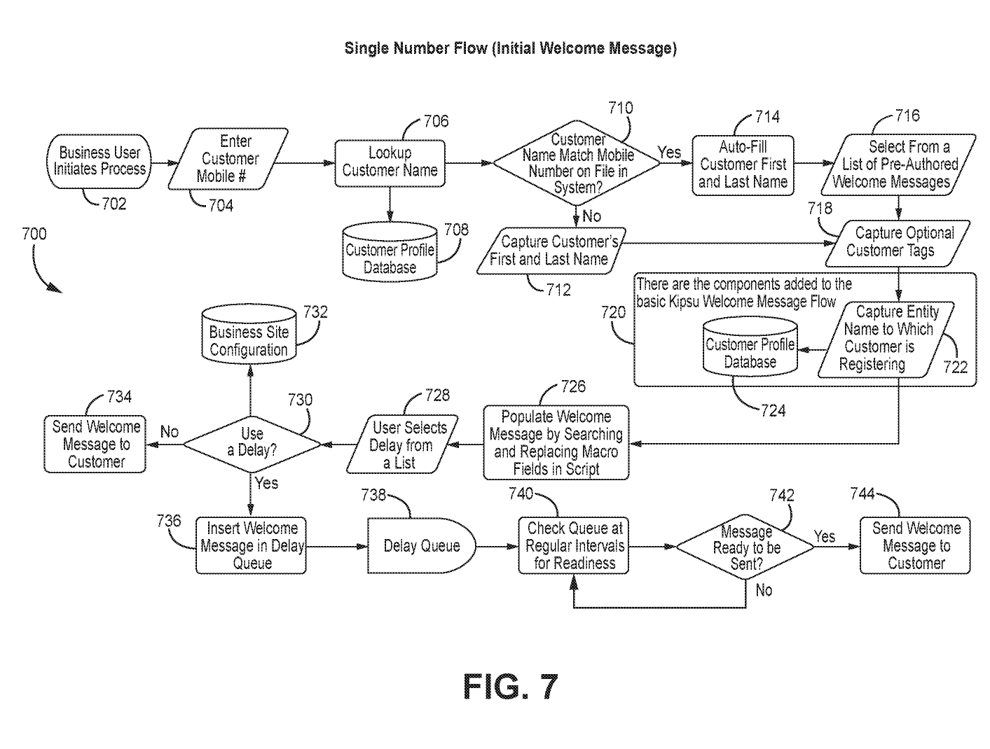

FIGS. 7-10 show processes or portions of processes that allow a business to market a single contact phone number to a large group of customers, such as all of their customers. The processes in FIGS. 7-10 can route incoming messages to an appropriate subdomain, team, or portion of the business that the guest is associated with or being served by.

FIG. 7 shows a schematic of a communication routing process, according to an embodiment. The process 700 can include a business user or team member initiating the process 702, such as by opening software associated with the process. The team member can enter the customer's mobile phone number 704. The process 700 can lookup or search the customer's name 706, such as in a customer profile database 708. The customer profile database 708 can include customers that have been previously entered in the process. In an embodiment, the customer profile database 708 can include previous messages sent and received by the customer.

The process 700 can determine if the customer's name matched a mobile number in the database 710. If the customer's name did not match, the business user can enter the customer's first and last name into the system 712. If the customer's name did match, the process 700 can auto-fill the customer's first and last names 714. The process 700 can select from a list of pre-authored welcome messages 716. The pre-authored welcome message that is selected can be sent to the customer. The process can capture optional customer tags 718 and include the optional customer tag in the welcome message to the customer.

The process 700 can include additional components added to the basic welcome message 720, such as the basic welcome message describe in FIG. 2. The process can capture an entity name to which the customer is registering 722, such as based on the customer profile database 724.

The process 700 can populate a welcome message such as by searching and replacing macro field in a script 726. The script can be pre-authored, such that a single team member could send multiple welcome messages to numerous customers in a relatively short amount of time.

The process 700 can include a delay, such as a delay from the time the welcome message is ready to be sent to the time the message is sent. The team member can select a delay from a list 728.

The process 700 can determine if the team member has selected a delay or not 730. The delay can also be related to certain configurations for the business site 732. If a delay is not being used, the welcome message can be sent to the customer 734. If a delay is being used, the welcome message can be inserted into a delay queue 736. The delay queue 738 can include welcome messages that are delayed from being sent.

They delay queue 738 can be checked at a regular interval for readiness 740. In an embodiment, the regular interval is no longer than the shortest delay. If the message is ready to be sent 742 the message is sent to the customer 744. If the message is not ready to be sent 742, the message remains in the delay queue.

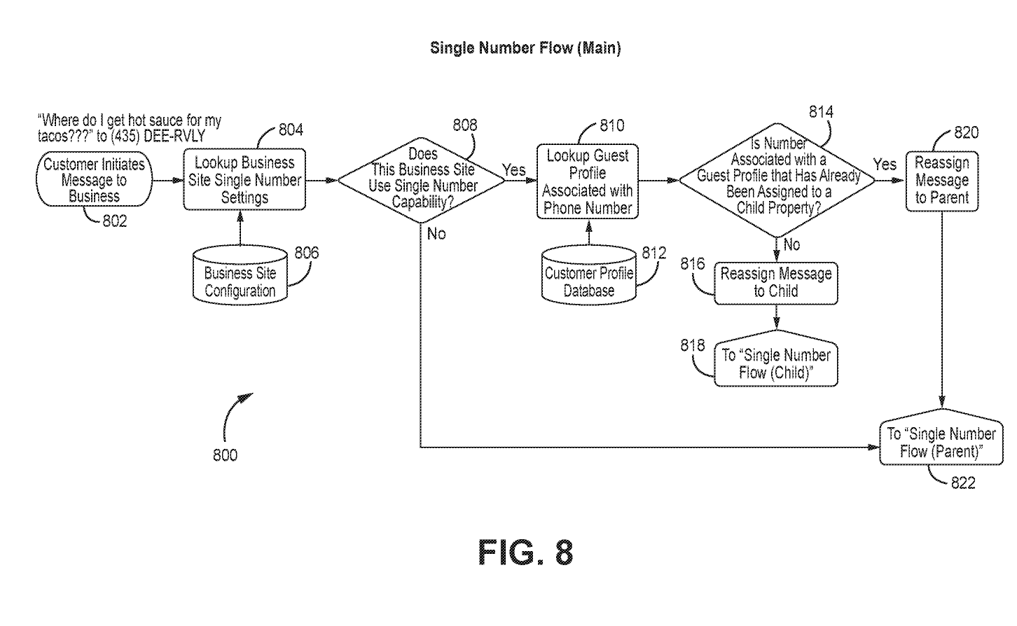

FIG. 8 is a schematic of a communication routing process 800, according to an embodiment. The process 800 can include the customer initiating a message to the business 802. The process 800 can include looking up the business site single number setting 804, such as the setting for the single number marketed to all guests. The process 800 can look up the setting in the business site configuration 806.

The process 800 can determine if the business uses a single number 808. If the business does not use a single number the message is directed to the single number flow 822. If the business does use a single number, the process 800 can lookup a guest profile associated with the phone number 810, such as from the customer profile database 812.

The process 800 can include determining if the number associated with the guest profile has already been assigned to a child 814, if not, the message is reassigned to the child 816 and the message is routed to the single number flow 818. If it is, then the message is reassigned to the parent 820 and the message is directed to the single number flow 822.

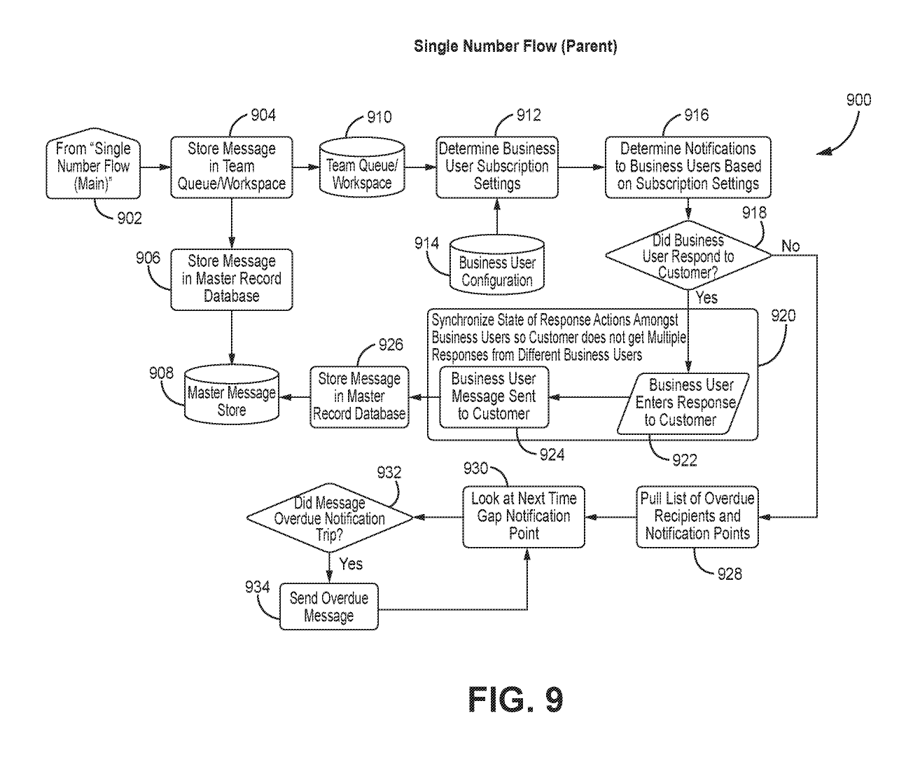

FIG. 9 is a schematic of a communication routing process 900 of a single number flow for a parent, according to an embodiment. The process 900 can receive a message from a single number flow 902, such as described in FIG. 8. The process 900 can include storing the message in a team queue or workspace 904. The message can be stored 906 in a master message storage 908. The team queue 910 can include messages received by the business and in need of a response from a team member.

The process 900 can include determining a business user's subscription settings 912, such as based on the business user configuration 914. The process 900 can include distributing notifications to the business users (team members) based on the subscription settings 916. The process 900 can include determining if a team member has responded to the customer 918.

If a team member has responded, the process 900 can include synchronizing the state of response amongst the team members 920, such that a customer does not receive multiple responses to a single message. The process 900 can include the team member entering a response to the customer 922 and the team member sending the message to the customer 924. The message can be stored 926, such as in the master message storage 908.

If a team member has not responded, the process 900 can include pulling a list of overdue recipients and notification points 928. Then the process can include looking at the next time gap notification point 930. The process 900 can determine if the message overdue notification has tripped 932. If so, an overdue message can be sent 934 to the team members.

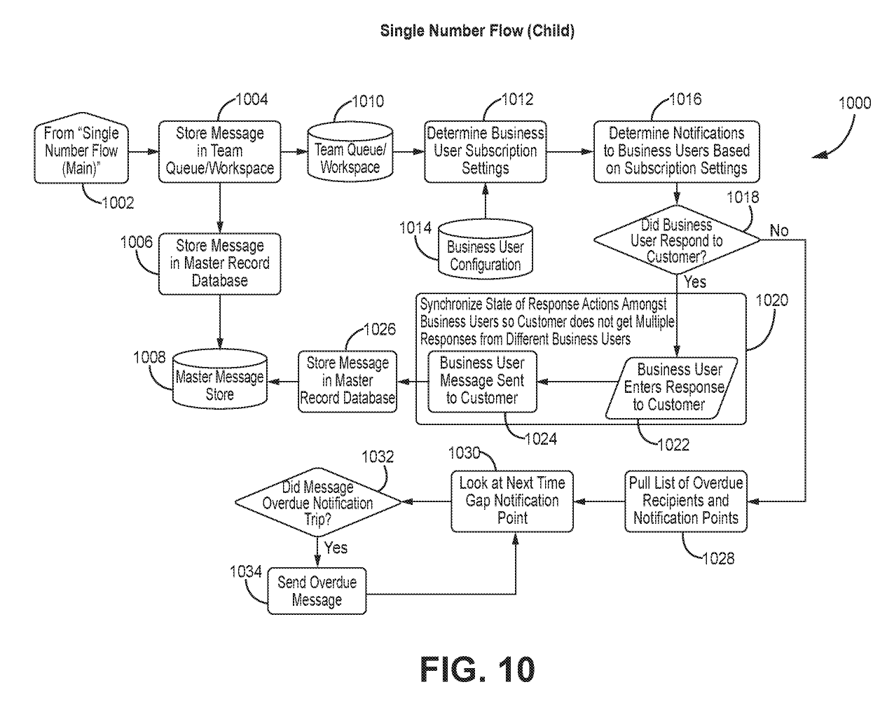

FIG. 10 is a schematic of a communication routing process 1000 of a single number flow for a child, according to an embodiment. The process 1000 can receive a message from a single number flow 1002, such as described in FIG. 8. The process 1000 can include storing the message in a team queue or workspace 1004. The message can be stored 1006 in a master message storage 1008. The team queue 1010 can include messages received by the business and in need of a response from a team member.

The process 1000 can include determining a business user's subscription settings 1012, such as based on the business user configuration 1014. The process 1000 can include distributing notifications to the business users (team members) based on the subscription settings 1016. The process 1000 can include determining if a team member has responded to the customer 1018.

If a team member has responded, the process 1000 can include synchronizing the state of response amongst the team members 1020, such that a customer does not receive multiple responses to a single message. The process 1000 can include the team member entering a response to the customer 1022 and the team member sending the message to the customer 1024. The message can be stored 1026, such as in the master message storage 1008.

If a team member has not responded, the process 1000 can include pulling a list of overdue recipients and notification points 1028. Then the process can include looking at the next time gap notification point 1030. The process 1000 can determine if the message overdue notification has tripped 1032. If so, an overdue message can be sent 1034 to the team members.

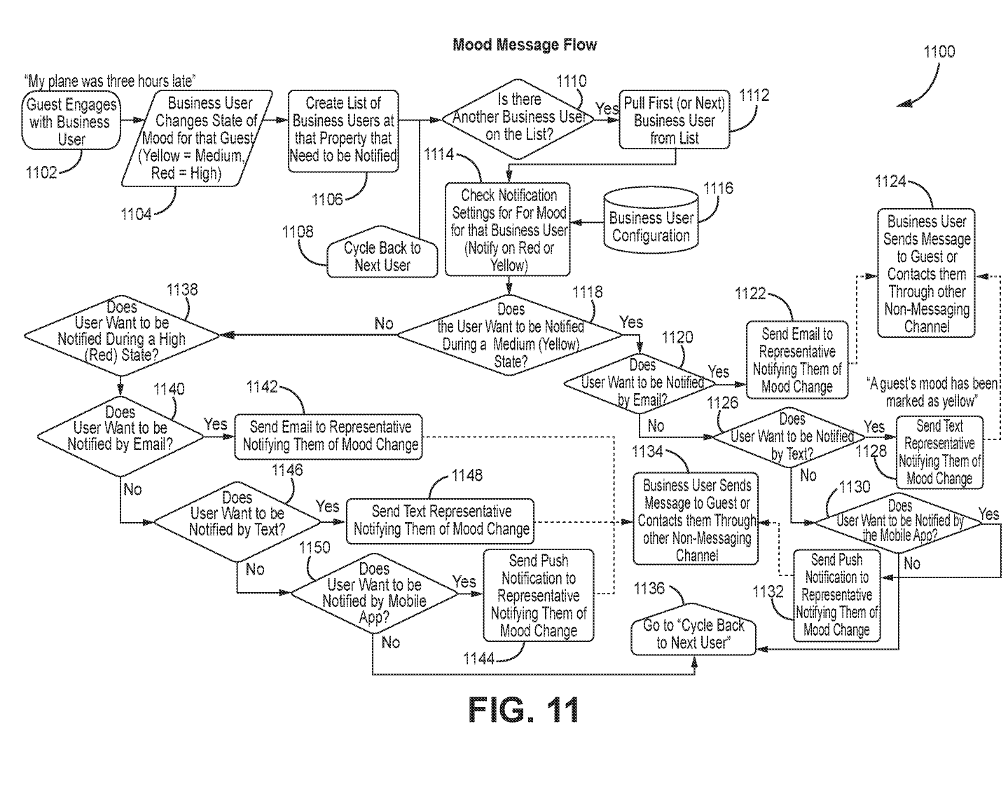

FIG. 11 shows a schematic of a customer mood evaluation process 1100, according to an embodiment. The process 1100 can create an alarm for specific customers that might be in a particularly angry or upset mood. The process 1100 can notify team members to be aware for those specific types of moods based on their preferences (mobile app, email, text).

The process 1100 can include a customer engaging the business 1102, such as by stating his/her plane is late. The team member can change the state of mood for that customer 1104. In an embodiment, different colors represent different severities, such as yellow for medium and red for high. A list of team members at the business that need to be notified of the customer's mood can be created 1106.

The process 1100 can cycle back to the next team member 1108 for the next steps. The process 1100 can include determining if there is another team member on the list 1110. If there is, the process 1100 can include retrieving the next team member from the list 1112. The process 1100 can include checking the notification settings for mood for that team member, such as notify when red or yellow. The notification settings are based on the team member's configuration 1116.

The process 1100 can include determining if the team member wants to be notified for a medium state 1118. If the team member does, then the process 1100 can determine if the team member wants to be notified by email 1120. If the team member does want to be notified by email 1120 then an email to the team member of the mood can be sent 1122. The team member can then contact the customer 1124.

If the team member does not want to be notified by email 1120, then the process 1100 can determine if the team member wants to be notified by a text message 1126. If the team member does want to be notified by a text message then a text can be sent to the team member notifying him/her of the customer's mood 1128. The team member can then contact the customer 1124.

If the team member does not want to be notified by a text message, the process 1100 can determine if the team member wants to be notified by the mobile application 1130. The team member can be notified of the customer's mood 1132. Then the team member can send a message to the customer or contact the customer in an alternative method 1134. If the team member does not want to be notified by the mobile application, the process 1100 can cycle back to the next user 1136, 1108.

If the team member does not want to be notified of a customer's mood for a medium state, then the process 1100 can include determining if the team member wants to be notified for a high state 1138. If the team member does, then the process 1100 can determine if the team member wants to be notified by email 1140. If the team member does want to be notified by email 1140 then an email to the team member of the mood can be sent 1142.

If the team member does not want to be notified by email 1140, then the process 1100 can determine if the team member wants to be notified by a text message 1146. If the team member does want to be notified by a text message then a text can be sent to the team member notifying him/her of the customer's mood 1148. The team member can then contact the customer 1134.

If the team member does not want to be notified by a text message, the process 1100 can determine if the team member wants to be notified by the mobile application 1150. The team member can be notified of the customer's mood 1144. If the team member does not want to be notified by the mobile application, the process 1100 can cycle back to the next user 1136, 1108.

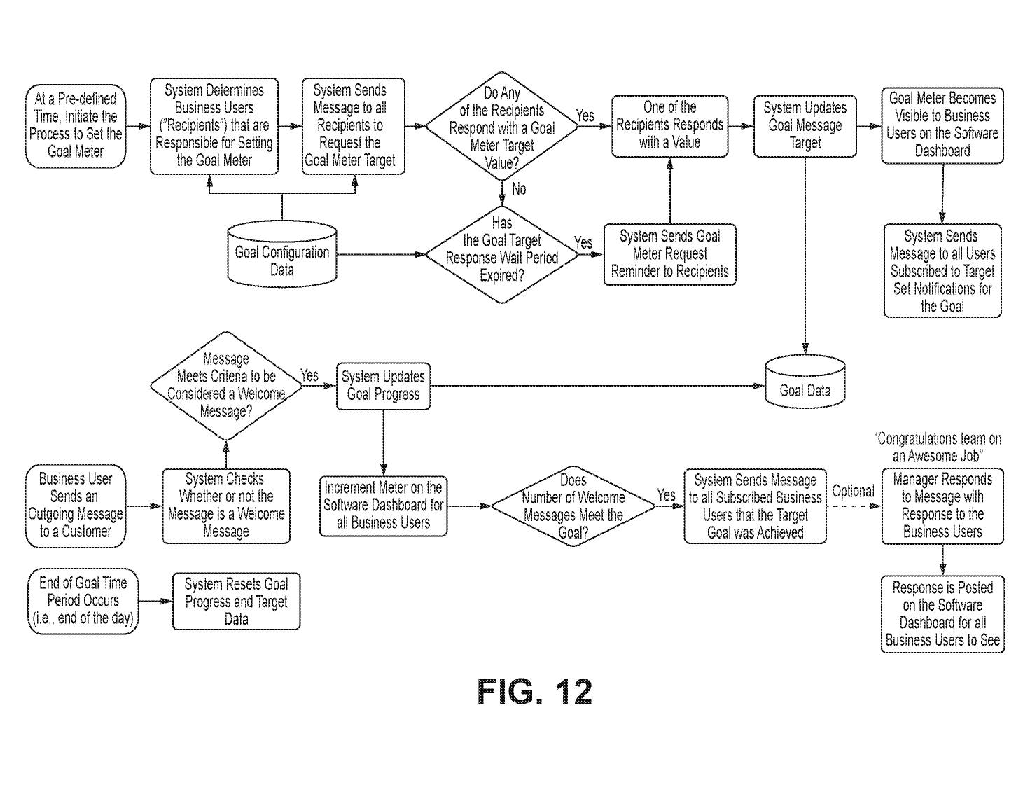

FIG. 12 shows an example welcome message process, including steps from a pre-defined time in which a process is set for goal metering, thhrou various steps relating tou updating goal message, targets, etc.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A process as described herein.

2. A method as described herein.
